(19) United States
(12) Patent Application Publication
(10) Pub. No.: US 2008/0241593 A1
(43) Pub. Date: Oct. 2, 2008

(54) POLYPARAXYLYLENE COMPOSITE FILM

(75) Inventor: Hiroo Hasebe, Wako-shi (JP)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: RIKEN

(21) Appl. No.: 11/779,719

(22) Filed: Jul. 18, 2007

(30) Foreign Application Priority Data
Jul. 18, 2006 (JP) 2006-195530

(51) Int. Cl. B32B 9/04; B05D 1/36

(52) U.S. Cl. 428/704; 427/407.1

(57) ABSTRACT

The present invention provides a composite film that excels in strength, even if its area is large, and in handleability, and has longer operating life. The present invention is a composite film including: a first film that contains at least one selected from the group consisting of metallic oxides, metallic compounds, metals and carbon; and a second film that contains polyparaxylylene having a structural unit expressed by the general formula (I).

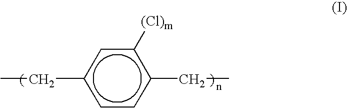

### CROSS-REFERENCE TO RELATED APPLICATIONS

The present application claims priority to Japanese Patent Application Number 2006-195530, filed Jul. 18, 2006, which is hereby incorporated by reference for all purposes.

### FIELD OF THE INVENTION

The present invention relates to a polyparaxylylene composite film.

### BACKGROUND OF THE INVENTION

Thin films are used for many applications, such as electrodes or partitions for separating two different kinds of electrolytes, in many technical fields. However, thin films have a problem in terms of strength because they are thin.

For example, in the acceleration of an ion beam, in order to increase the efficiency of the acceleration, a target film is used to strip electrons off the accelerated ions. Such a target film is usually an extremely thin film of carbon. The ion beam accelerated by an accelerator can pass through this film while preserving practically all of its energy. On the other hand, electrons remaining around the ions are stripped off by the target film, thereby producing multicharged ions. The multicharged ion beam thus obtained can change its orbit in magnetic fields with relative ease.

However, in target films made of a carbon film, the life span of the target films is generally short. They would be easily damaged when irradiated with an ion beam, thereby significantly decreasing the availability factor of the accelerator used.

Coating sheets obtained by coating the surface of carbon films with cellulose nitrate used to be common, although such films are not commercially available now. Such films likely were prepared by coating the surface of carbon films with an organic solvent containing cellulose nitrate. Such a coating has the effect of protecting target films, but on the other hand, it is costly and its storable period is short when stored in the form of a laminate placed on a substrate. In addition, in such films, the thickness of the carbon thin film portion is limited to 3 μg/cm² to 20 μg/cm².

### SUMMARY OF THE INVENTION

In the light of such circumstances, it is an object of the present invention to provide a composite film having excellent film strength and handleability, even where its area is large.

The present invention has been made to solve the above described problem. Specifically, the composite film according to the present invention comprises: a first film that may contain at least one selected from the group consisting of metallic oxides, metallic compounds, metals and carbon; and a second film that may contain polyparaxylylene having a structural unit expressed by the following general formula (I):

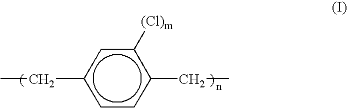

wherein

m is 0 or 1, and m being 0 means that nothing is bonded; and

n is an integer of 5000 or larger.

A method, according to the present invention, for producing a target thin film for beam irradiation may comprise the steps of: coating a carbon thin film on a substrate with a releasing agent in between; forming a polyparaxylylene film on the above carbon thin film; and separating the composite of the above carbon thin film and polyparaxylylene film from the substrate by immersing the same in an aqueous solvent.

A method according to the present invention for producing a target film for beam irradiation may comprise the steps of: coating a polyparaxylylene film on a substrate, if desired, using a releasing agent in between; forming a carbon thin film on the above polyparaxylylene film; and separating the composite of the above polyparaxylylene film and carbon thin film from the substrate.

In the present invention, a film containing a polymer, i.e. polyparaxylylene, may be deposited on another film, whereby the resultant thin film has improved handleability during work and its yield may be increased. Further, such a thin film composite may have increased strength so that the film composite having a large area can be held by any holder, for example by a holder having an aperture therein.

### BRIEF DESCRIPTION OF THE DRAWINGS

FIG. 1 is a bar graph, which compares the lifetime of carbon films of different film thicknesses with that of composite films prepared by coating 10 to 20 μg/cm² of polyparaxylylene on each of the above carbon films.

### DETAILED DESCRIPTION OF THE PREFERRED EMBODIMENT(S)

The present invention relates to a composite film including: a first film that contains at least one selected from the group consisting of metallic oxides, metallic compounds, metals and carbon; and a second film that contains a polyparaxylylene film (hereinafter sometimes referred to as “polyparaxylylene film”).

Examples of the metallic oxides used may include, but not limited to, titanium oxide, aluminum oxide, ZnO, MgO, InSbO and InZnO and combinations thereof.

The metallic compounds contain a metallic element, other than the above described metallic oxides. Examples of the metallic compounds used may include, but are not limited to, metallic carbides such as niobium carbide and tantalum carbide; metallic sulfide such as ZnS; metallic fluorides such as MgF₂; metallic nitrides; and combination thereof.

Examples of the metals used may include, but are not limited to, simple metals such as gold, silver, copper, tantalum, tungsten, nickel, cobalt, molybdenum; or alloys thereof: Cu—Ga, Ni—Cu, Ni W, Al—Ti, Al—Cr, Al—Ta, Ge—Sb—Te, Ag—In—Sb—Te, Tb—Fe—Co, Gd—Fe—Co, Co—Cr—Ta and Ni—Ti; and their combination thereof.

The use of carbon is described in greater detail below.

In the composite film of the present invention, the second film is a film that contains polyparaxylylene having a structural unit expressed by the above general formula (I). Although m in formula (I) may be 0 or 1, preferably m is 1 because the polyparaxylylene easily evaporates and disappears when exposed to the beam. The m being 0 means that nothing is bonded. In the present specification and claims, the term “lack of bonding” means that a hydrogen atom is bonded to a carbon atom that is a constituent of a benzene ring.

The reference character n is an integer of 5000 or larger.

Preferably, the amount of the first film, per coated layer, in the composite film of the present invention ranges from 5 to 100 μg/cm². More preferably, the lower limit of the amount of the first film, per coated layer, is 20 μg/cm², further preferably 30 μg/cm², and particularly preferably 40 μg/cm². If the amount of the first film coated is within the above range, it is possible to allow the composite film ultimately obtained to have excellent strength while maintaining the life of the same almost the same level as that of the carbon thin film, as a simple film.

Preferably, the amount of the second film in the composite film of the present invention may range from 10 μg/cm² to 30 μg/cm². If the amount of the second film is 10 μg/cm² or more, the second film can cover the entire surface as a monolayer, thereby provide sufficient strength to the composite film. If the amount of the second film is 30 μg/cm² or less, thermal expansion characteristic etc. of the polymer film of the second film are less likely to affect the first film, which makes it possible for the composite film as a whole to withstand the beam.

In the present specification and claims, “the amount of the film coated” is expressed in terms of mass per unit area, and it is a value obtained by measuring the change in the weight before and after the coating with an electronic precision balance.

The composite film of the present invention includes at least one layer of the first film and at least one layer of the second film as is apparent from the expression “the amount of the film, per coated layer”, however, the composite film of the invention may include a film prepared by coating a second film on a first film, followed by coating another first film on the second film. The composite film of the invention may include a film having a sandwich structure where two or more layers of first film and two or more layers of second film are alternately coated.

Even where forming the sandwich structure, the amount of the first film, per coated layer, present in the composite film of the present invention may preferably range from 5 to 100 μg/cm² and the amount of the second film, per coated layer, present in the composite film of the present invention preferably may range from 10 to 30 μg/cm². If the amounts of the first film and the second film coated are within the above range, respectively, it is possible to allow the final composite film to have excellent strength while maintaining the life of the same almost the same level as that of a carbon thin film alone.

When forming the sandwich structure, the coating can be performed until the total amount of the first film coated reaches 1 mg/cm² and the total amount of the polyparaxylylene film, as the second film, coated reaches 200 to 400 μg/cm².

Accordingly, the total amount of the first and second films present in the composite film of the present invention may range from 15 μg/cm² to 1.4 mg/cm².

In the composite film of the present invention, the first film may be any one of thin films of metallic oxides, metallic compounds, metals and carbon; while, a carbon thin film is preferable.

The carbon in the above carbon thin film means carbon of a type that can be formed by deposition. Either conductive or non-conductive carbon can be used. Such types of carbon may include, for example, carbon nanotube, fullerene, diamond, amorphous carbon and graphite.

The above carbon thin film may have increased strength by coating the above polyparaxylylene film thereon. If it is used for a target thin film for beam irradiation, the risk of its breakage may be significantly decreased during the separation of the target film from the substrate used in its production, during the attachment of the film to an aperture holder, during the attachment of the film-attached aperture holder to a beam irradiation apparatus, or during the evacuation process or pressure-bleeding process in the apparatus. Thus, the carbon thin film coated by polyparaxylylene may be particularly effective in that it may improve the yield of the production for carbon thin film and cover the difference of the work skill between individual workers.

Preferably, the amount of the carbon thin film, per coated layer, present in the composite film of the present invention may range from 5 to 100 μg/cm² and the amount of the polyparaxylylene film, per coated layer, present in the composite film of the present invention may range from 10 to 30 μg/cm². If the amounts of the carbon thin film or the polyparaxylylene film coated may respectively fall within the above range, respectively, it may be possible to allow the composite film to have excellent strength while maintaining the lifetime of the same almost the same level as that of a carbon thin film alone.

The size of the composite film of the present invention may be, for example, 20 mm to 100 mm in diameter. If the composite film having such a large area is used as a target thin film for beam irradiation, rotating the composite film makes it unnecessary to irradiate a beam on the same spot of the film and makes the lifetime of the film significantly extended.

When the composite film of the present invention is irradiated with, for example, ion beams, the temperature at the beam spot increases. If the temperature increases to about 200° C. or higher, the polyparaxylylene film evaporates, allowing the first film alone to remain. Even where the polyparaxylylene film is sandwiched between the first films so that it exists inside, if the inside temperature increases to about 200° C. or higher, it evaporates and only the first films remain. Thus, the composite film can be handled in the same manner as the first film alone, and therefore, when the first film is composed of carbon, the composite film can be suitably used as a target thin film for beam irradiation, just like a film of carbon alone. On the other hand, the second film remains on the place beside a beam spot, whereby the strength of the composite film, as a whole, is kept higher.

The polyparaxylylene film, as a second film, does not necessarily cover the entire surface of the first film. The polyparaxylylene film can partly cover the first film with a prescribed pattern or can cover only the part of the first film where it needs to be reinforced. In the production method to be described, however, as long as patterning or masking is not performed, the polyparaxylylene film usually covers the entire surface of the first film, including the substrate, which forms the composite film.

The composite film of the present invention can be suitably used for a target film for the beam irradiation. A target thin film for beam irradiation is a thin film to be irradiated with an ion beam or a laser light.

One aspect of the method for producing a target thin film for beam irradiation according to the present invention (hereinafter referred to simply as “the first production method of the present invention”) comprises the steps of: coating a carbon thin film on a substrate with a releasing agent in between; forming a polyparaxylylene film on the above carbon thin film; and separating the above composite film from the substrate by immersing the same in an aqueous solvent.

The first production method of the present invention comprises the steps of coating a carbon thin film on a substrate with a releasing agent in between.

Examples of materials employed for the surface of the substrate include, but not limited to, metals and glass. A material easily separable from the carbon thin film coated is more preferably used.

As the releasing agent coated on the substrate before the coating of the carbon thin film, a water-soluble one is preferably used because the composite film to be formed is immersed in an aqueous solvent in a later step. Examples of such releasing agents include: chlorides of alkaline metals, alkaline earth metals, transition metals or lanthanoids, such as NiCl₂, NaCl and LaCl₃.

The coating of the releasing agent on the substrate surface is carried out by deposition using a resistance heating evaporation source.

After the releasing agent is coated on the substrate, the carbon thin film can be coated using arc discharging or sputtering source. However, such a film as prepared in the steps so far is commercially available, and therefore, a commercially available one can be used as a substitute.

The first production method of the present invention comprises the step of forming a polyparaxylylene film on the above carbon thin film.

As a method for coating a polyparaxylylene film on the above carbon thin film, deposition is preferable from the viewpoint of forming a uniform film.

Deposition can be carried out in, for example, a deposition apparatus that includes a raw-material vaporization zone, a pyrolysis zone and a deposition zone in this order while placing a substrate, on which a carbon thin film has been deposited in advance, in the deposition zone special for polyparaxylylene.

First a solid dimer of diparaxylylenes, as a raw material, expressed by the general formula (II) below (where two “m”s are independently an integer of 0 or 1, and m being 0 means non-bonded) is allowed to evaporate in the raw-material vaporization zone.

The vaporizing temperature employed is desirably 40° C. to 175° C. The vaporization can be performed under reduced pressure at 1 torr (133 Pa) or lower.

The obtained vaporized dimer is carried to the pyrolysis zone to undergo pyrolysis, thereby producing a stable diradical paraxylylene expressed by the formula (III) below.

The pyrolysis temperature is desirably 600° C. to 680° C. Normally, the pyrolysis can be performed under reduced pressure at 0.5 torr (67 Pa) or lower.

The formed diradical paraxylylene is carried to the deposition zone, where the compounds are polymerized mutually at the same time or after it is adsorbed on the surface of the carbon thin film formed on the substrate to form a high-molecular weight polyparaxylylene film expressed by the general formula (IV) below.

The polymerization temperature is preferably ordinary temperature, desirably, 20° C. to 35° C., in terms of preventing the evapotranspiration or decomposition of the releasing agent coated on the substrate and in terms of preventing the deformation or damage of the carbon thin film formed on the substrate. Normally, the polymerization can be performed under reduced pressure at 0.1 torr (13 Pa) or lower.

An excess of diradical paraxylylene can be recovered usually at around −70° C. by providing a cooling dome in the downstream.

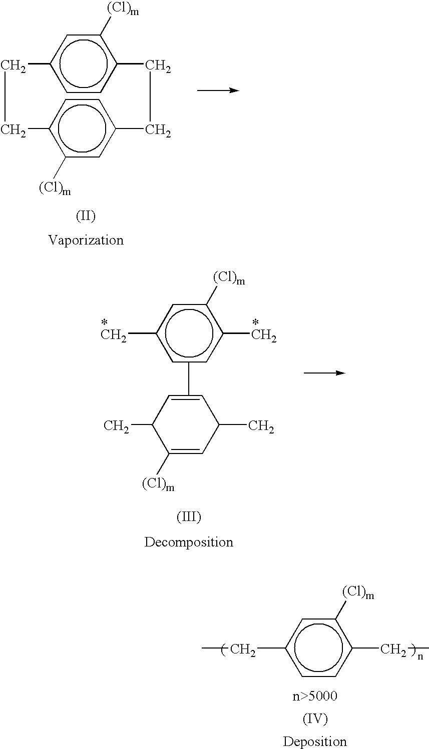

The first production method of the present invention comprises the step of separating the composite of the above carbon thin film and the polyparaxylylene film from the substrate by immersing the composite in an aqueous solvent. The above aqueous solvent is a solvent or solution containing water. Examples of such aqueous solvent include water and water having a small amount of alcohol added.

When the substrate is immersed in an aqueous solvent at 10 to 40° C., the carbon thin film is separated from the substrate with the polyparaxylylene film coated on its surface, because the releasing agent soluble in the aqueous solvent has been deposited in advance between the carbon thin film and the substrate, as described above, and the carbon thin film is usually suspended in the aqueous solvent. It is possible to conform that the suspended matter is the composite of the above carbon thin film and the polyparaxylylene film by checking the difference in color of each surface or checking whether they are evaporated by irradiating of beam.

The target thin film for beam irradiation of the present invention obtained in the above steps has increased strength compared with a carbon thin film as a simple film, and therefore, it can be easily set up to, for example, an aperture holder having an aperture diameter of 100 mm or larger, to which the conventional target thin films cannot be set up.

It has been known that carbon thin films set up to an aperture holder are easily broken by vibration or wind. For example, generally target thin films for beam irradiation are used under vacuum conditions when a beam is allowed to pass through such thin films in an accelerator. And it is known that when evacuation is started with a target thin film set in a chamber, a target thin film composed of a carbon thin film alone is likely to break unless the evacuation speed is made slow. In contrast, the target thin film for beam irradiation of the present invention has the advantage of being able to withstand the substantial mechanical impact or the impact of the wind and being less likely to break.

In another aspect of the method for producing a target thin film for beam irradiation of the present invention (hereinafter referred to simply as the second production method), a target thin film can be formed by the method comprising a step of: forming a polyparaxylylene film on a substrate, if desired, with a releasing agent in between; forming a carbon thin film on the above polyparaxylylene film; and separating the composite of the above polyparaxylylene film and the carbon thin film from the substrate.

In this case, examples of materials employed for the surface of the substrate, include, but not limited to, metals and glass.

Examples of releasing agents used when desired include, but not limited to, surfactants, such as a soap solution, and oils, such as vacuum grease.

When using the above releasing agent, the coating of the releasing agent on the substrate surface may be carried out by manually rubbing the releasing agent impregnated into a cloth etc. onto the substrate so that a very small amount of the releasing agent is coated uniformly on the surface of the substrate.

The step of forming a polyparaxylylene film and forming a carbon thin film following the coating step of the releasing agent on the substrate may be carried out in the same manner as those of the above described production method of the present invention.

The step of separating the composite, which has been formed on the substrate as above, from the substrate may be carried out by, for example, applying an adhesive material on the peripheral edge of the portion on the composite surface which is intended to be separated as a film and exerting the force in such a direction that the adhesion of the adhesive material to the polyparaxylylene film is released, for example, in a peeling direction vertical to the substrate.

The adhesive material used is not limited to any specific one as long as it has adhesion to the surface of the composite. When the surface of the composite is a polyparaxylylene film, for example, adhesive tape, such as commercially available adhesive cellophane tape, can be used.

Preferably, the place to which the adhesive material is applied is the surface of the polyparaxylylene film.

One or more layers of the above carbon thin film and the polyparaxylylene film can be formed and they can be formed into a sandwich structure as described above.

The other uses of the composite film of the present invention are not limited to any specific ones. Examples of its uses include: packing; optical fiber; thin films for display devices such as transparent conductive films, liquid crystal BM films, electrode films and plasma display protective films; thin films for recording media such as magnetic metal films, magnetic optical disks, phase-change optical disks, reflective films and protective films; thin films for electronic components such as hybrid IC, relays, thermistors, bobbins, capacitors, frequency filters, hall elements, magnetic heads, thermal heads, miniature motors, circuit boards, microprobe pins, coils, sensors, switches, stepping motors, varistors, transformers, piezoelectric components and connectors; car electronics; thin films for cells such as thin film solar cells, fuel cells and lithium cells; thin films for scientific instruments; thin films for solid chemicals; decorative thin films; and thin films for surface-hardening.

In the following the present invention will be described in more detail by a non-limited example.

### EXAMPLE

A laminate of 40 μg/cm² of carbon thin film on a substrate (surface material: glass) (ACF-40, manufactured by ACF-METALS) was observed at ×10000 magnification with an electron microscope, and the observation revealed that a concavity or convexity and carbon particles having a particle diameter of μm-order existed on the surface of the laminate.

The surface of a laminate prepared by coating 10 to 20 μg/cm² of polyparaxylylene film on the above carbon thin film was also observed, and the observation revealed that a very thin film of polyparaxylylene was coated uniformly on the surface and the surface was changed to be smoother. The observation also revealed that the polyparaxylylene film was not laminated as a separated layer from the carbon thin film, but formed in uniform thickness, conforming to the uneven surface of the carbon film.

Then, two samples were prepared for each of the carbon-film coated substrates prepared by coating 10 μg/cm², 20 μg/cm², 40 μg/cm² or 80 μg/cm² of carbon thin film on a substrate (surface material: glass) (ACF-10, ACF-20, ACF-40 and ACF-80, respectively, manufactured by ACF-METALS. The size of the substrates was 1 in.×3 in. (2.54 cm×7.62 cm)).

One of the carbon-film coated substrates was set in the coating chamber of Parylene coating system (LABCOTER PDS 2010, manufactured by SPECIALTY COATING SYSTEMS), and 2-chloro-diparaxylylene (manufactured by SPECIALTY COATING SYSTEMS) was vaporized at 175° C., 1 Torr and pyrolytically decomposed at 680° C., 0.5 Torr, and 10 to 20 μg/cm² of polyparaxylylene film was coated on the substrate at 35° C., 0.1 Torr.

On another carbon-film coated substrate, no polyparaxylylene film was coated.

Immersing these substrates in water allowed the films to be separated from the substrates. It was revealed that the obtained films were carbon thin films and composite films of carbon and polyparaxylylene films.

Each of the obtained composite films was fixed to a holder having an aperture diameter of 14 mm in such a manner as to allow the film to cover the aperture, and the chamber was evacuated with a vacuum pump to not more than 1×10⁻⁴ Pa.

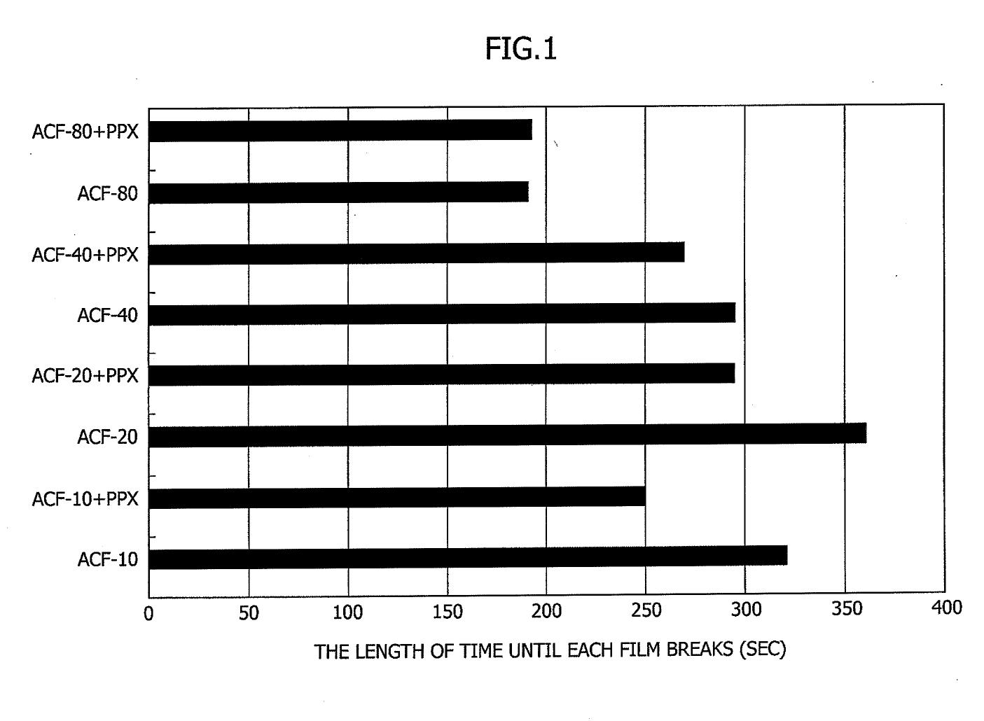

The center of each composite film was then irradiated with Xe⁹⁺ beam (beam diameter: 5 mmΦ, beam current: 3.78 eμA, energy: 33 keV/nuclear), and the life of each composite film, that is, the length of time required for the film to break was measured. The comparison of the life among the composite films is shown in FIG. 1.

According to FIG. 1, in the composite films prepared by coating a polyparaxylylene film (PPX) on the carbon thin films of 10 μg/cm² (ACF-10) and 20 μg/cm² (ACF-20), their life tends to be a little short, but on the other hands, in the composite films prepared by coating the polyparaxylylene film (PPX) on the carbon thin films of 40 μg/cm² (ACF-40) and 80 μg/cm² (ACF-80), their life was the same as or longer than that of the carbon thin film, as a simple film.

The carbon thin films of ACF-10 and ACF-20 were thin, compared with those of ACF-40 and ACF-80, and were very likely to break when handled. Thus, even if their life, that is, the length of time required for them to break due to beam irradiation is slightly decreased, their merit of enhanced handleability provided by the deposition of a polyparaxylylene film compensates for the shortcoming.

Accordingly, with the composite films used in the present invention, the merit of increased strength becomes larger, the handleability is improved and the actual life becomes larger.

1. A composite film comprising: a first film that contains at least one selected from the group consisting of metallic oxides, metallic compounds, metals and carbon; and a second film that contains polyparaxylylene having a structural unit expressed by the following general formula (I): 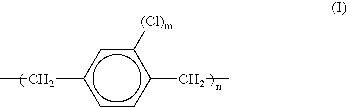
wherein
m is 0 or 1, and m being 0 means that nothing is bonded; and
n is an integer of 5000 or larger.

2. The composite film according to claim 1, wherein the total amount of the first and second films coated is 15 μg/cm² to 1.4 mg/cm².

3. The composite film according to claim 1, wherein the amount of the first film, per coated layer, ranges from 5 to 100 μg/cm² and the amount of the second film, per coated layer, ranges from 10 to 30 μg/cm².

4. A target thin film for beam irradiation using a composite film according to claim 1.

5. A target thin film for beam irradiation using a composite film according to claim 2.

6. A target thin film for beam irradiation using a composite film according to claim 3.

7. A method for producing a target thin film for beam irradiation, comprising the steps of:
coating a carbon thin film on a substrate with a releasing agent between the carbon thin film and the substrate;
coating a polyparaxylylene film on the carbon thin film; and
separating the composite of the carbon thin film and the polyparaxylylene film from the substrate by immersing the composite in an aqueous solvent.

8. A method for producing a target thin film for beam irradiation, comprising the steps of:
coating a polyparaxylylene film on a substrate, optionally, with a releasing agent between the polyparaxylylene film and the substrate;
forming a carbon thin film on the polyparaxylylene film; and
separating the composite of the polyparaxylylene film and the carbon thin film from the substrate.
